(19) United States
(12) Patent Application Publication
(10) Pub. No.: US 2026/0312888 A1
(43) Pub. Date: Oct. 8, 2026

(54) MANAGING A NETWORK FUNCTION IN A COMMUNICATION NETWORK DOMAIN

(71) Applicant: Telefonaktiebolaget LM Ericsson (publ), Stockholm (SE)

(72) Inventors: Sabrine AROUA, Antony (FR); Mathieu LECONTE, Verrières-le-Buisson (FR); Hossein SHOKRI GHADIKOLAEI, Täby (SE); Pegah ALIZADEH, Paris (FR)

(73) Assignee: Telefonaktiebolaget LM Ericsson (publ), Stockholm (SE)

(21) Appl. No.: 19/481,620

(22) PCT Filed: May 5, 2023
(86) PCT No.: PCT/EP2023/062065

§ 371 Date: Nov. 5, 2025

(51) Int. Cl. H04L 41/5025; H04L 41/16; H04L 41/5009

(52) U.S. Cl. CPC H04L 41/5025; H04L 41/16; H04L 41/5009

(57) ABSTRACT

A system is disclosed for managing performance of a communication network domain comprising a plurality of Network Functions (NFs). The system comprises a management node and a plurality of learning nodes, each learning node comprised within a NF in the communication network domain. The management node is configured to provide, to each of a plurality of NFs in the communication network domain, at least one performance goal to be achieved by the NF, and to inform each of the plurality of NFs of which other NFs it should cooperate with to achieve its performance goal. Each of the learning nodes is configured to use a Multi Agent Reinforcement Learning (MARL) process to generate a policy for selecting actions to be executed by its NF so as to achieve its performance goal, wherein the agents in the MARL process comprise the learning node and the learning nodes of each of the NFs that the learning node's NF is to cooperate with.

### TECHNICAL FIELD

The present disclosure relates to a method for managing a network function in a communication network domain, and to a method for managing performance of a communication network domain. The methods may be performed by a learning node of a Network Function, and by a management node, respectively. The present disclosure also relates to a learning node, a management node, and to a computer program product configured, when run on a computer, to carry out methods for managing a network function in a communication network domain, and for managing performance of a communication network domain.

### BACKGROUND

The 5th generation mobile network (5G) brings more complexity to communication network infrastructure and services management. In 5G networks, multiple network customers, i.e., named Mobile Network Service (MNS) consumers, coexist to exploit different services. Energy and telecommunication operators are examples of these network consumers. Every network consumer has specific expectations from the network and service management. Using the concept of the intent-driven system, the MNS consumer goals and expected behaviours of an autonomous network system can be clearly defined as one or more intents. An intent provides information about a particular objective for the network, and may include some related details, as set out in “Intent driven management services for mobile networks (3GPP 28.312). An intent should respect the following constraints:
An intent should be understandable by humans.
An intent describes the “What” (an outcome to be achieved by the network), rather than the “How” (how that outcome should be achieved).
The expectations expressed in an intent should be agnostic to the underlying system implementation, technology, and infrastructure.
An intent should be quantifiable from network data, so that an achieved result can be measured and evaluated.

The intent concept therefore enables MNS consumers to abstract their requirements, such as may be expressed in, for example, service level agreements (SLAs). MNS consumers submit their desired outcome in the form of one or more intents to the End-to-End (E2E) Management and Orchestration entity, without going into details about how to achieve the desired goals.

Every time there is a request for a new intent, the E2E manager first translates the intent, defining this submitted intent's requirements, goals, and constraints, as set out in 3GPP 28.312 references above. The E2E manager then submits this new form of intent to the network automation application, where the associated Intent Management Function (IMF) analyses this intent's feasibility at the resource level. The IMF may be for example a RAN (Radio Access Network) IMF, a CN (Core Network) IMF, a TN (Transport Network) IMF, or a Cloud IMF, and the corresponding resource level may consequently be RAN, core, transport, or cloud. For simplicity, the following disclosure considers the example of a RAN domain, with associated IMF and resources, although it will be appreciated that similar issues may be found in COMMUNICATION NETWORK, TN, and Cloud domains.

Considering the example RAN domain, after analysing a received intent's feasibility at the resource level, the RAN IMF designs different Network Functions (NFs) to realize the defined goals. Every NF learns an appropriate policy which specifies the actions to be taken when a given condition occurs in the network. The RAN IMF from the higher level may also be involved in explaining rules for the NFs on how to behave in specific scenarios. FIG. 1 illustrates an example of system architecture for intent deployment.

Assigned NFs work to realize well-defined objectives, or sub-goals, received from the higher IMF. Every NF behaves according to its learned policy and rules to satisfy the MNS consumers' intents. Individual NFs exploit different actions and manage multiple Key Performance Indicators (KPIs) in the network to achieve their own assigned sub-goals. It will be appreciated that different NFs might impact disjoint sets of KPIs to achieve their intents. For example, FIG. 2 presents two examples NFs, NF1 and NF2, which might make conflicting decisions.

NF1 is assigned to fulfil the intents of a telecommunication operator in terms of Radio Link Failures (RLF) rate. To this end, it is assumed that NF1 controls the antenna tilt and power transmission of the different deployed Base stations (BSs). Based on the existing traffic load and user Equipment distribution, NF1 manages these two parameters to ensure good coverage and minimize the radio link failure rate. NF2 is assigned to realize the intent of an energy operator, which aims to maintain the total energy consumed by the BSs below a specific target value. To this end, NF2 switches ON/OFF the different BSs.

NF1 and NF2 are thus seeking to achieve two conflicting goals, acting on conflicting key performance indicators (KPI). Different conflicts might exist between NF1 and NF2 to realize their associated sub-goals, and fulfil the relevant intents. For example, at time t, NF2 may decide to switch ON/OFF some base stations to reduce the overall energy consumption of the network. However, the NF2 decision might negatively affect NF1's goals if a high traffic load exists at time t, meaning that the coverage and power transmission should be maximized to avoid link failure.

NF1 and NF2 can be located in the same network slice or in different network slices. Generally, the IMF from the higher level, and the end-to-end orchestrator, are responsible for solving conflicts among NFs. When deploying NF1 and NF2, the higher IMF, i.e., the RAN IMF, defines potential states (or conditions) of the surrounding environment that might create conflicts between existing NFs. The assigned NFs then behave according to learned policies and rules provided by the higher-level entities.

Given the complexity of the network, the IMFs cannot cover all the environmental conditions that might create conflicts between intents assigned to the different NFs. In existing systems, if a new conflict appears in the network, the higher IMF and the E2E manager will observe the infeasibility of the intents, and the non-achievement of the assigned NF sub-goals. As a result, the higher IMFs are responsible for solving the conflicts. An IMF might for example redefine sub-goals assigned to the impacted NFs. The redefined sub-goals should satisfy the requirements of the MNS consumers. Alternatively, the E2E manager may inform the MNS consumers of the non-feasibility of their intents.

Different studies have intent management and, more particularly, solving conflicts between different sub-goals assigned to a diverse range of RAN NFs. In Perepu, Satheesh K., Jean P. Martins, and Kaushik Dey. “Multi-agent reinforcement learning for intent-based service assurance in cellular networks.” arXiv preprint arXiv: 2208.03740 (2022), the authors propose a solution based on a Multi-agent Reinforcement Learning technique to enable multiple deployed agents to achieve different and potentially conflicting intents by collaborating without human intervention. In case of conflict between the different assigned objectives, the proposed solution prioritizes certain KPIs to resolve conflicts. In Banerjee, Anubhab, Stephen S. Mwanje, and Georg Carle. “Contradiction Management in Intent-driven Cognitive Autonomous RAN.” 2022 IFIP Networking Conference (IFIP Networking). IEEE, 2022, a new architectural design is introduced to help detect and remove contradictions among learned policies during the runtime, i.e., while processing the intents.

Each of the disclosures mentioned above proposes a centralized solution for intent conflict management, and consequently suffers from inconveniences including E2E delay, a single-point-of-failure, and scalability issues. For example, adding more intents or NFs without upgrading the hardware or the software of the central entity may result in significant processing delays.

### SUMMARY

It is an aim of the present disclosure to provide methods, a learning node, a management node, and a computer program product which at least partially address one or more of the challenges mentioned above. It is a further aim of the present disclosure to provide methods, a learning node, a management node, and a computer program product which cooperate to facilitate distributed management of NFs for fulfilment of intents through consensus.

According to a first aspect of the present disclosure, there is provided a computer implemented method for managing a Network Function (NF) in a communication network domain, wherein the NF comprises a learning node, and is operable to execute actions in the communication network domain, and wherein the actions executed by the NF impact at least one performance measure for the communication network domain. The method, performed by the learning node of the NF, comprises receiving, from a management node in the communication network, a performance goal to be achieved by the NF, and an indication of neighbour NFs in the communication network domain. The neighbour NFs comprise NFs that are operable to execute actions in the communication network domain that impact at least one of the performance measures impacted by actions operable to be executed by the NF. The method further comprises obtaining a current state representation for the communication network domain, and receiving, from the indicated neighbour NFs, a value of a parameter representing an extent to which the respective neighbour NF is currently able to achieve its performance goal. The method further comprises using the current state representation and received parameter values in a Reinforcement Learning (RL) process to select an action for execution in the communication network domain, and initiating execution of the selected action.

According to another aspect of the present disclosure, there is provided a method for managing performance of a communication network domain. The method, performed by a management node in the communication network, comprises providing, to each of a plurality of Network Functions (NFs) in the communication network domain, at least one performance goal to be achieved by the NF, and providing, to each of the plurality of NFs, an indication of neighbour NFs in the communication network domain. The neighbour NFs of an NF comprise NFs that are operable to execute actions in the communication network domain that impact at least one of the performance measures impacted by actions operable to be executed by the NF.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a learning node for managing a Network Function (NF) in a communication network domain, wherein the NF is operable to execute actions in the communication network domain, and wherein the actions executed by the NF impact at least one performance measure for the communication network domain. The learning node comprises processing circuitry configured to cause the learning node to receive, from a management node in the communication network, a performance goal to be achieved by the NF, and an indication of neighbour NFs in the communication network domain. The neighbour NFs comprise NFs that are operable to execute actions in the communication network domain that impact at least one of the performance measures impacted by actions operable to be executed by the NF. The processing circuitry is further configured to cause the learning node to obtain a current state representation for the communication network domain, and receive, from the indicated neighbour NFs, a value of a parameter representing an extent to which the respective neighbour NF is currently able to achieve its performance goal. The processing circuitry is further configured to cause the learning node to use the current state representation and received parameter values in a Reinforcement Learning (RL) process to select an action for execution in the communication network domain, and initiate execution of the selected action.

According to another aspect of the present disclosure, there is provided a management node of a communication network, wherein the management node is for managing performance of a communication network domain. The management node comprises processing circuitry configured to cause the management node to provide, to each of a plurality of Network Functions (NFs) in the communication network domain, at least one performance goal to be achieved by the NF, and provide, to each of the plurality of NFs, an indication of neighbour NFs in the communication network domain. The neighbour NFs of an NF comprise NFs that are operable to execute actions in the communication network domain that impact at least one of the performance measures impacted by actions operable to be executed by the NF.

According to another aspect of the present disclosure, there is provided a system for managing performance of a communication network domain comprising a plurality of Network Functions (NFs) wherein each NF is operable to execute actions in the communication network domain, and wherein the actions executed by a NF impact at least one performance measure for the communication network domain. The system comprises a management node and a plurality of learning nodes, each learning node comprised within a NF in the communication network domain. The management node is configured to provide, to each of a plurality of NFs in the communication network domain, at least one performance goal to be achieved by the NF, and to inform each of the plurality of NFs of which other NFs it should cooperate with to achieve its performance goal. Each of the learning nodes is configured to use a Multi Agent Reinforcement Learning (MARL) process to generate a policy for selecting actions to be executed by its NF so as to achieve its performance goal, wherein the agents in the MARL process comprise the learning node and the learning nodes of each of the NFs that the learning node's NF is to cooperate with.

Aspects of the present disclosure thus provide methods and nodes that enable distributed management of intent fulfilment through consensus between NFs. Examples of the present disclosure avoid a centralised single point of failure, and support network intelligence, scalability, and autonomy by allowing individual NFs to react to their communication network domain environment, and to discover a policy that will support the performance goals of both the individual NF, and of NFs whose performance goals may be in conflict or competition that of the individual NF.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates an example system architecture for intent deployment;

FIG. 2 illustrates example NFs which might make conflicting decisions;

FIG. 3 is a flow chart illustrating process steps in a computer implemented method for managing an NF in a communication network domain;

FIG. 4 is a flow chart illustrating process steps in a computer implemented method for managing performance of a communication network domain;

FIGS. 5a to 5c show flow charts illustrating another example of a computer implemented method for managing an NF in a communication network domain;

FIGS. 6a and 6b show flow charts illustrating another example of a method for managing performance of a communication network domain;

FIG. 7 is a block diagram illustrating functional modules in an example learning node;

FIG. 8 is a block diagram illustrating functional modules in an example management node;

FIG. 9 illustrates an example graph of NFs;

FIG. 10 illustrates operation at a single NF learning node; and

FIG. 11 illustrates an overview of actions at a system comprising a plurality of learning nodes at individual NFs, and a management node.

### DETAILED DESCRIPTION

As discussed above, in existing systems, intent conflicts are always solved by higher IMFs and the E2E manager. This centralized intent management imposes a potentially long end-to-end delay, in addition to a central point of failure. Centralised management may involve managing and controlling all the sub-goals assigned to the different NFs, which is only sometimes practical. In addition, the existing centralised management causes NFs to behave in an open loop, and in a passive manner.

Examples of the present disclosure enable different NFs to control and manage their intents locally, so underpinning an E2E automated/intelligent system. In such a system, it is desirable for NFs to become capable of meeting network customers' expectations without always coming back to the higher IMF. While existing propositions seek to enable reactive behaviour in NFs, for example through a MARL solution, a centralized supervisor agent is always the leading decision maker. An additional challenge for current systems is that multiple heterogeneous MNS consumers (i.e., vendors) coexist, with each consumer having specific intents. These consumers have varying privacy concerns, and many consumers will not accept revealing their requirements and sub-goals to other consumers. If enabling NFs to manage conflicts locally, maintaining privacy of individual sub-goals is an important constraint that is not addressed in any existing proposal.

Examples of the present disclosure propose a distributed solution for intent management that is based on Multi-Agent Reinforcement Learning (MARL). MARL is used to manage intent conflicts between assigned NFs that are working to realize different sub-goals. Methods according to the present disclosure enable NFs with a specific sub-goal to communicate with neighbouring NFs, which may for example be conflicting NFs, to find a reasonable consensus without revealing the concerned NFs' sub-goals. Potentially conflicting NFs can therefore learn policies that account for eventual conflicts. NFs will select actions that respect their own and neighbouring NFs' sub-goals without revealing those sub-goals, so achieving privacy-protected closed-loop decision-making.

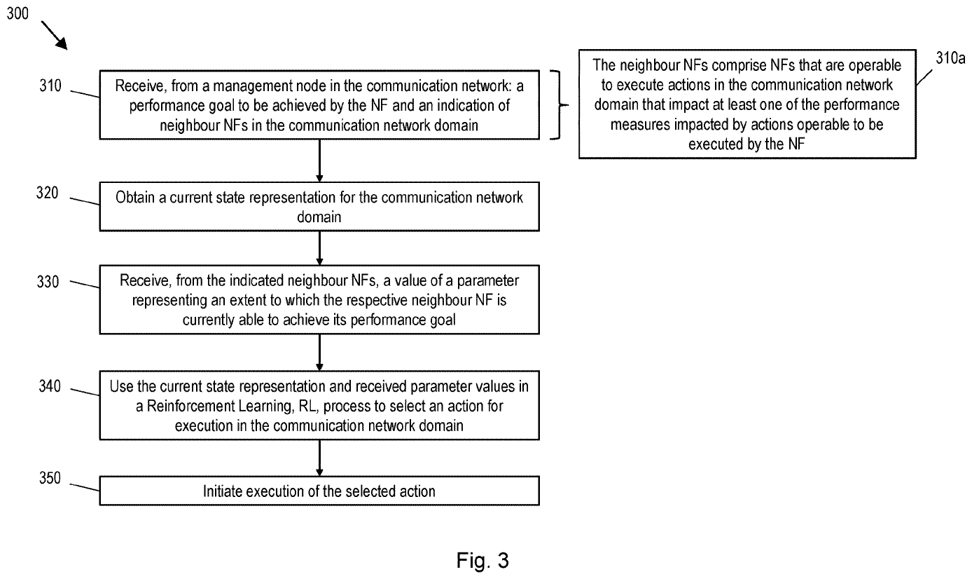

FIG. 3 is a flow chart illustrating process steps in a computer implemented method 300 for managing an NF in a communication network domain. The communication network domain may for example comprise a Radio Access Network (RAN) domain, a Core Network (CN) domain, a Transport Network (TN) domain, or a Cloud domain. The NF comprises a learning node, and is operable to execute actions in the communication network domain. The actions executed by the NF impact at least one performance measure for the communication network domain. The method 300 is performed by the learning node of the NF. The learning node may comprise a physical or virtual node, and may be implemented in a computer system, computing device or server apparatus and/or in a virtualized environment, for example in a cloud, edge cloud, an Open Radio Access Network, O-RAN, or fog deployment. Examples of a virtual node may include a piece of software or computer program, a code fragment operable to implement a computer program, a virtualised function, or any other logical entity. The learning node may encompass multiple logical entities, as discussed in greater detail below.

Referring to FIG. 3, the method 300 comprises, in step 310, receiving, from a management node in the communication network, a performance goal to be achieved by the NF, and an indication of neighbour NFs in the communication network domain. A performance goal may for example comprise a target to be achieved by the NF in terms of communication network performance. The goal might for example be a specific target value of one or more performance measures, which comprise metrics used to measure performance of the communication network, and which could be network Key Performance Indicators (KPIs). The performance goal may comprise a “sub-goal” as discussed above, that is a performance objective to be achieved by the NF so as to fulfil a MNS consumer intent. As illustrated at 310a, the neighbour NFs comprise NFs that are operable to execute actions in the communication network domain that impact at least one of the performance measures impacted by actions operable to be executed by the NF. The method 300 further comprises, in step 320, obtaining a current state representation for the communication network domain, and in step 330, receiving, from the indicated neighbour NFs, a value of a parameter representing an extent to which the respective neighbour NF is currently able to achieve its performance goal. The method 300 further comprises using the current state representation and received parameter values in a Reinforcement Learning (RL) process to select an action for execution in the communication network domain in step 340, and, in step 350, initiating execution of the selected action.

It will be appreciated that the method 300 enables cooperation between neighbour NFs, such that they may learn a policy that takes account of neighbour NF's performance goals. Privacy of performance goals is maintained by the sharing of a parameter that represents reward (to what extent to an NF is achieving its goal), as opposed to the reward itself. In some examples, NFs may receive more than one performance goal from the management node, and each NF may operate a plurality of learning nodes, for example one learning node for each performance goal received by the NF.

In some examples, the management node may also provide rules for operation in the network to the different NFs. Such rules may be used by the NFs alongside the method 300 discussed above to make decisions that avoid conflicts. The NFs may for example update rules provided by the management node, and/or create new rules, according to the policies learned using examples of the method 300.

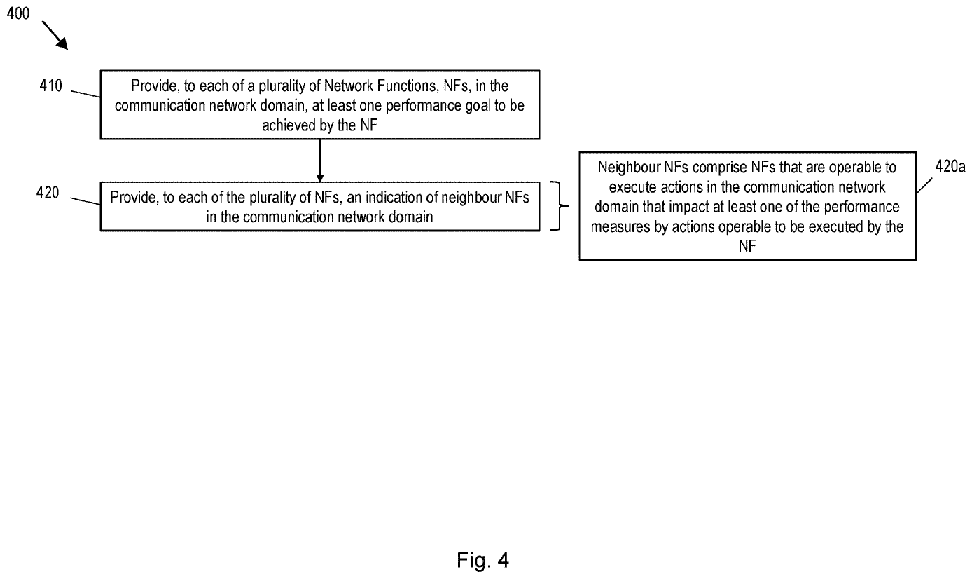

The method 300 may be complemented by a method 400 performed by a management node. FIG. 4 is a flow chart illustrating process steps in a method 400 for managing performance of a communication network domain. The communication network domain may for example comprise a Radio Access Network (RAN) domain, a Core Network (CN) domain, a Transport Network (TN) domain, or a Cloud domain. The method is performed by a management node in the communication network. The management node may comprise a physical or virtual node, and may be implemented in a computer system, computing device or server apparatus and/or in a virtualized environment, for example in a cloud, edge cloud, an Open Radio Access Network, O-RAN, or fog deployment. Examples of a virtual node may include a piece of software or computer program, a code fragment operable to implement a computer program, a virtualised function, or any other logical entity. The communication network may comprise an LTE network, a 5G network or any other existing or future communication network system, and the management node may for example comprise an Intent Management Function (IMF). The management node may encompass multiple logical entities, as discussed in greater detail below.

Referring to FIG. 4, the method 400 comprises, in step 410, providing, to each of a plurality of NFs in the communication network domain, at least one performance goal to be achieved by the NF. The method further composites, in step 420, providing, to each of the plurality of NFs, an indication of neighbour NFs in the communication network domain. As illustrated at 420a, neighbour NFs comprise NFs that are operable to execute actions in the communication network domain that impact at least one of the performance measures impacted by actions operable to be executed by the NF. In some examples, the management node may also provide rules for operation in the network to the different NFs. Such rules may be used by the NFs alongside the method 300 discussed above to make decisions that avoid conflicts. The NFs may for example update rules provided by the management node, and/or create new rules, according to the policies learned using examples of the method 300.

Different types of NF may be deployed in different communication network domains. For the purposes of the present disclosure, a wide range of examples of NFs may benefit from the methods disclosed herein. The following discussion includes an example form each of the above discussed communication network domains, for the purposes of illustration, but it will be appreciated that other NFs in the different communication network domains may also benefit from the methods disclosed herein. In a Cloud domain, an NF may comprise an agent responsible for CPU and memory allocation for the different Virtualised Network Functions (VNFs). The actions of this NF may include scale-up/scale-down the allocated CPU and/or memory. A performance measure by which this NF may be measured includes the KPI for process time of each VNF under the requested workload. In a RAN domain, an NF may comprise an agent that sets the antenna tilt angle. The actions of this NF may include tilt angle adjustments (tilt-up/tilt-down) of the antenna. A performance measure by which this NF may be measured includes the KPI for coverage and interference. In a TN domain, an NF may comprise a packet forwarding node. The actions of this NF may include processing and forwarding received packets on a per-packet basis. A performance measure by which this NF may be measured includes the KPI for minimising forwarding delay. In a COMMUNICATION NETWORK domain, an NF may comprise an Access and Mobility Management Function (AMF). Actions of this NF may include establishing and releasing the control plane signalling connections between a UE and the AMF. A performance measure by which this NF may be measured includes the KPI for Ping pong effect.

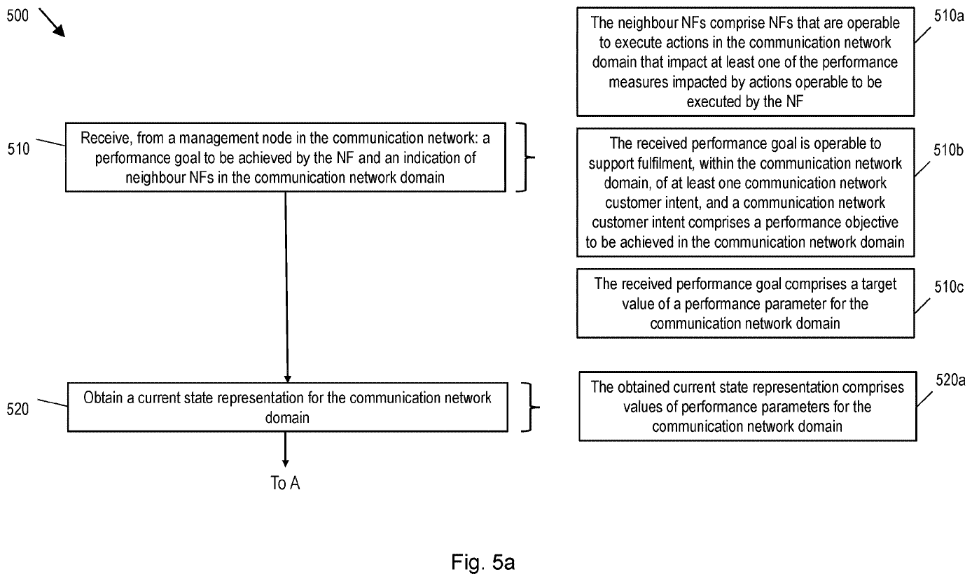

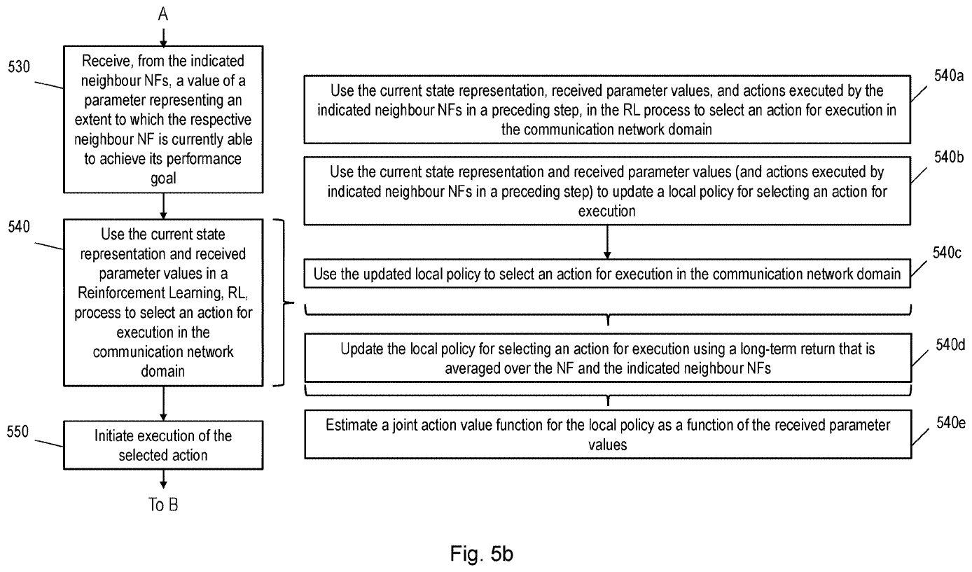

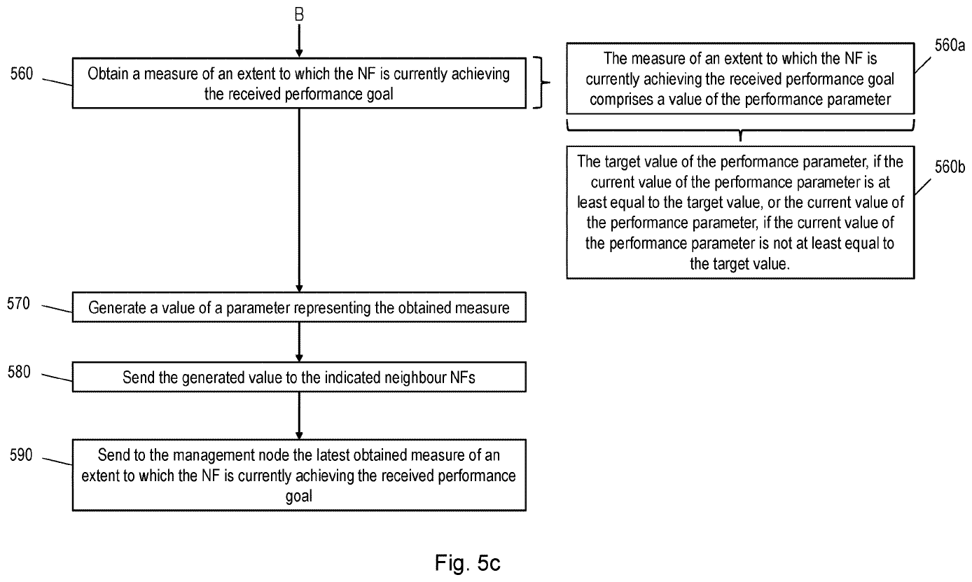

FIGS. 5a to 5c show flow charts illustrating another example of a computer implemented method 500 for managing an NF in a communication network domain. As for the method 300 discussed above, the communication network domain may for example comprise a Radio Access Network (RAN) domain, a Core Network (CN) domain, a Transport Network (TN) domain, or a Cloud domain. The NF comprises a learning node, and is operable to execute actions in the communication network domain. The actions executed by the NF impact at least one performance measure for the communication network domain. The method 500 is performed by the learning node of the NF. The learning node may comprise a physical or virtual node, and may be implemented in a computer system, computing device or server apparatus and/or in a virtualized environment, for example in a cloud, edge cloud, an Open Radio Access Network, O-RAN, or fog deployment. Examples of a virtual node may include a piece of software or computer program, a code fragment operable to implement a computer program, a virtualised function, or any other logical entity. The learning node may encompass multiple logical entities, as discussed in greater detail below. The method 500 illustrates examples of how the steps of the method 300 may be implemented and supplemented to provide the above discussed and additional functionality.

Referring initially to FIG. 5a, in a first step 510, the learning node receives, from a management node in the communication network, a performance goal to be achieved by the NF, and an indication of neighbour NFs in the communication network domain. As discussed above, a performance goal may for example comprise a target to be achieved by the NF in terms of communication network performance. The goal might for example be a specific value of one or more performance measures, which comprise metrics used to measure performance of the communication network, and which could be network Key Performance Indicators (KPIs). The performance goal may comprise a “sub-goal” as discussed above, that is a performance objective to be achieved by the NF so as to fulfil a MNS consumer intent. As illustrated at, 510a, the neighbour NFs comprise NFs that are operable to execute actions in the communication network domain that impact at least one of the performance measures impacted by actions operable to be executed by the NF.

As illustrated at 510b and mentioned above, the received performance goal may be operable to support fulfilment, within the communication network domain, of at least one communication network customer intent, wherein a communication network customer intent comprises a performance objective to be achieved in the communication network domain. As illustrated at 510c, the received performance goal may comprise a target value of a performance parameter for the communication network domain. Such performance parameters may include for example latency, total throughput, Radio Link Failures, power consumption, interference, Ping Pong handovers, Load, Packet-loss ratio (PLR), Overhead, average Reference Signal Received Power (RSRP), coverage area, etc, in addition to those discussed above.

In step 520, the learning node obtains a current state representation for the communication network domain. As illustrated at 520a, the obtained current state representation may comprise values of performance parameters for the communication network domain. In some examples, the performance parameters included in the state representation may comprise the set of all parameters that are impacted by actions executed by the NFs in the communication network domain.

Referring now to FIG. 5b, in step 530, the learning node receives, from the indicated neighbour NFs, a value of a parameter representing an extent to which the respective neighbour NF is currently able to achieve its performance goal. The learning node may receive parameters from all or only a subset of the indicated neighbour NFs. The parameter may for example comprise a normalised value of a function of one or more performance measures. For example, if the performance goal of an NF comprises a target value of a performance measure, then the parameter representing an extent to which the respective neighbour NF is currently able to achieve its performance goal may comprise a function of, for example, a current measured value of the performance measure and the target value of the performance measure. The shared parameters enable neighbour NFs to take account of the extent to which their neighbours are achieving their own performance goals, without sharing those goals between the different NFs.

In step 540, the learning node uses the current state representation and received parameter values in a Reinforcement Learning (RL) process to select an action for execution in the communication network domain. As illustrated at 540a, this may comprise using the current state representation, received parameter values, and actions executed by the indicated neighbour NFs in a preceding step, in the RL process to select an action for execution in the communication network domain. Such actions may be determined or shared by the neighbour NFs.

In some examples, using the current state representation and received parameter values (and actions executed by the indicated neighbour NFs, if used) in a RL process to select an action for execution in the communication network domain may comprise using the current state representation and received parameter values to update a local policy for selecting an action for execution in step 540b, and using the updated local policy to select an action for execution in the communication network domain in step 540c. In some examples, step 540b may further comprise using the current state representation, received parameter values, and actions executed by the indicated neighbour NFs in a preceding step, to update a local policy for selecting an action for execution.

As illustrated in FIG. 5b, using the current state representation, received parameter values, and actions executed by the indicated neighbour NFs in a preceding step, to update a local policy for selecting an action for execution may comprise updating the local policy for selecting an action for execution using a long-term return that is averaged over the NF and the indicated neighbour NFs, in step 540d. Using the long-term return that is averaged over the NF and the indicated neighbour NFs may comprise selecting an action for execution so as to maximise the long-term return. This may comprise selecting an action that is predicted to increase the long-term return to the highest value that can be achieved, and may comprise seeking to achieve a global rather than a local maximum value of the long-term return.

In some examples, updating the local policy for selecting an action for execution using a long-term return that is averaged over the NF and the indicated neighbour NFs may comprise estimating a joint action value function for the local policy as a function of the received parameter values in step 540e. The joint action value function may be estimated using the parameter values received from the neighbour NFs as well as the NF's own generated parameter value from a preceding step.

Following step 540, the learning node then initiates execution of the selected action in step 550. This may comprise sending a message to an appropriate function within the NF to execute the action, or otherwise causing the action to be executed. In some examples, the action may comprise an adjustment to an operational parameter of the NF, in which case initiating execution of the action may comprise causing the operational parameter value to be changed in accordance with the selected action.

Referring now to FIG. 5c, in step 560, the learning node obtains a measure of an extent to which the NF is currently achieving the received performance goal. As discussed above and illustrated at 560a, this may comprise a value of a performance parameter, or may comprise a percentage amount of the target value of the performance parameter that is currently being achieved. In examples in which the performance goal provided to the NF is a target value of a performance parameter, the measure of an extent to which the NF is currently achieving the received performance goal may comprise a current measured value of the performance parameter. As illustrated at 560b, the measure of an extent to which the NF is currently achieving the received performance goal may comprise a value of the performance parameter that is:
the target value, if the current value of the performance parameter is at least equal to the target value; and
the current value, if the current value of the performance parameter is not at least equal to the target value.

In step 570, the learning node generates a value of a parameter representing the obtained measure. As discussed above, this may comprise a value of a function of the obtained measure. In step 5802, the learning node sends the generated value to the indicated neighbour NFs.

In step 590, the learning node sends to the management node the latest obtained measure of an extent to which the NF is currently achieving the received performance goal. It will be appreciated that as the management node provided the performance goal to the NF, the learning node can share with the management node the measure of an extent to which the NF is currently achieving the received performance goal. The privacy that is achieved by sharing parameters as opposed to actual measures between NFs would be superfluous when interacting with the management node.

In some examples of the present disclosure, the steps 520 (obtaining a current state representation for the communication network domain, 530 (receiving, from the indicated neighbour NFs, a value of a parameter representing an extent to which the respective neighbour NF is currently able to achieve its performance goal), 540 (using the current state representation and received parameter values in a RL process to select an action for execution in the communication network domain), 550 (initiating execution of the selected action), 560 (obtaining a measure of an extent to which the NF is currently achieving the received performance goal), 570 (generating a value of a parameter representing the obtained measure), and 580 (sending the generated value to the indicated neighbour NFs), may be repeated by the learning node for a plurality of time steps. The step 590 of sending to the management node a measure of an extent to which the NF is currently achieving the received performance may be carried out by the learning node each time step or with some other periodicity (for example every X time steps), or on a scheduled basis.

As discussed above, the communication network domain may comprise at least one of a Radio Access Network domain, a Core Network domain, a Transport Network domain, or a Cloud domain. For the purposes of illustration the following discussion sets out, for each of the above mentioned domains, an example communication network customer intent, in the form of a performance objective for the domain, and a corresponding performance goal for an NF in the domain, the performance goal being operable to support fulfilment of the intent (domain performance objective). In a RAN domain, an example customer intent may comprise energy saving “thresholds” for one or more base stations. The corresponding performance goal for an NF in the RAN domain may be reduce the power transmission of the relevant antenna. In a Cloud domain, an example customer intent may comprise using only a specified amount of CPU until a “VIP or urgent” process needs to be executed. The corresponding performance goal for an NF in the Cloud domain may be to allocate this total amount of CPU to the different processes while respecting the processing delays per category of process, with a VIP or urgent process having very strict delay. In a TN domain, an example customer intent may comprise Quality of Service (QoS) improvement. The corresponding performance goal for an NF in the TN domain may be to achieve load balancing between the different cells. In a CN domain, an example customer intent may comprise energy saving for the final user equipment. The corresponding performance goal for an NF (such as an AMF) in the CN domain may be to reduce the signalling cost of handover.

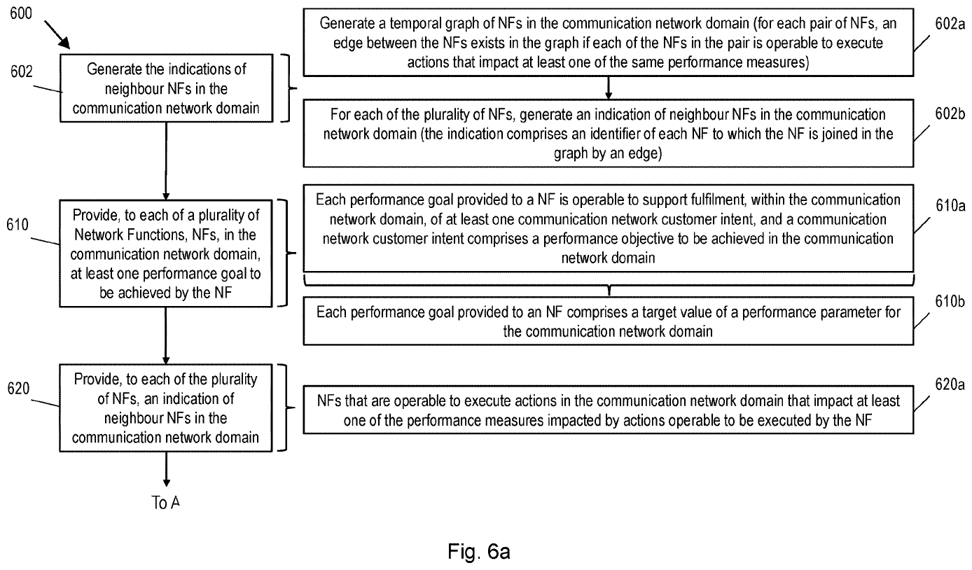

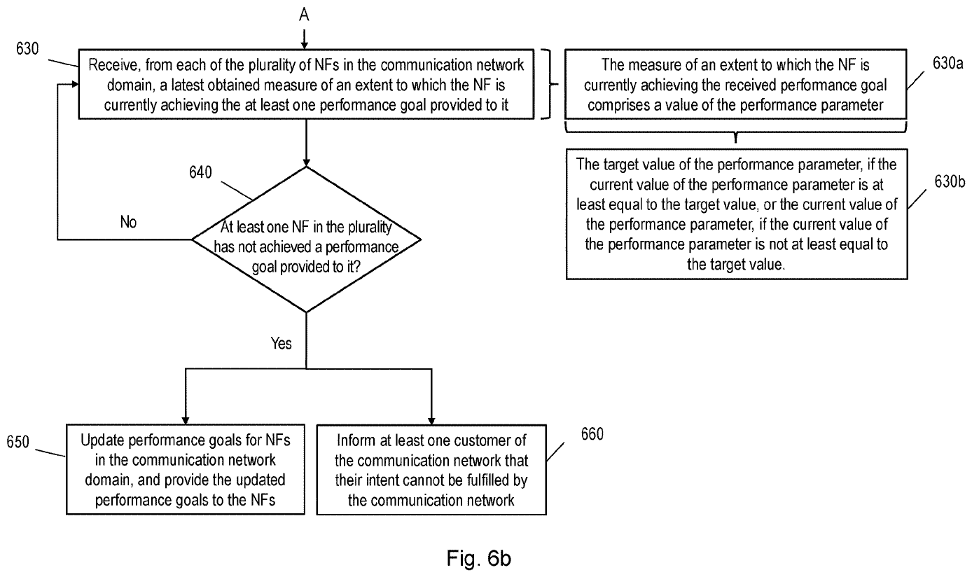

FIGS. 6a and 6b show flow charts illustrating another example of a method 600 for managing performance of a communication network domain. The communication network domain may for example comprise a Radio Access Network (RAN) domain, a Core Network (CN) domain, a Transport Network (TN) domain, or a Cloud domain. AS for the method 400 discussed above, the method 600 is performed by a management node in the communication network. The management node may comprise a physical or virtual node, and may be implemented in a computer system, computing device or server apparatus and/or in a virtualized environment, for example in a cloud, edge cloud, an Open Radio Access Network, O-RAN, or fog deployment. Examples of a virtual node may include a piece of software or computer program, a code fragment operable to implement a computer program, a virtualised function, or any other logical entity. The communication network may comprise an LTE network, a 5G network or any other existing or future communication network system, and the management node may for example comprise an Intent Management Function (IMF). The management node may encompass multiple logical entities, as discussed in greater detail below. The method 600 illustrates examples of how the steps of the method 400 may be implemented and supplemented to provide the above discussed and additional functionality.

Referring initially to FIG. 6a, in step 602, the management node generates indications of neighbour NFs in the communication network domain. As illustrated in FIG. 6a, this may comprise, in step 602a, generating a temporal graph of NFs in the communication network domain. In the temporal graph, for each pair of NFs, an edge between the NFs exists in the graph if each of the NFs in the pair is operable to execute actions that impact at least one of the same performance measures. Having generated the temporal graph, for each of the plurality of NFs, the management node may then generate an indication of neighbour NFs in the communication network domain in step 602b, wherein the indication comprises an identifier of each NF to which the NF is joined in the graph by an edge.

In step 610, the management node provides, to each of a plurality of NFs in the communication network domain, at least one performance goal to be achieved by the NF. As illustrated at 610a, each performance goal provided to a NF may be operable to support fulfilment, within the communication network domain, of at least one communication network customer intent, wherein a communication network customer intent comprises a performance objective to be achieved in the communication network domain. In some examples, the intent may be received by the management node, for example from an End-to-End Management and Orchestration layer. As discussed above, each performance goal provided to an NF may comprise a target value of a performance parameter for the communication network domain, as shown at 610b.

In step 620, the management node provides, to each of the plurality of NFs, an indication of neighbour NFs in the communication network domain. As illustrated at 620a, the neighbour NFs of an NF comprise NFs that are operable to execute actions in the communication network domain that impact at least one of the performance measures impacted by actions operable to be executed by the NF.

Referring now to FIG. 6b, in step 630, the management node receives, from each of the plurality of NFs in the communication network domain, a latest obtained measure of an extent to which the NF is currently achieving the at least one performance goal provided to it. In the case of performance goals comprising target values of a performance parameter for the communication network, the measure of an extent to which the NF is currently achieving the received performance goal may comprise a value of the performance parameter, as illustrated at 630a, or a percentage amount of the target value of the performance parameter that is currently being achieved. As shown in 630b, the value provided to the management node may comprise the target value, if the current value of the performance parameter is at least equal to the target value, or may comprise the current value, if the current value of the performance parameter is not at least equal to the target value.

The management node may then check whether or not all of the NFs in the plurality of NFs are achieving their performance goals in step 640. If at least one NF in the plurality has not achieved a performance goal provided to it, the management node may then perform either or both of updating performance goals for NFs in the communication network domain, and providing the updated performance goals to the NFs in step 650, and/or informing at least one customer of the communication network that their intent cannot be fulfilled by the communication network in step 660. In some examples, the management node may first which intent is linked to the goal that has not been achieved, and only informing the customer if it is not possible to satisfy all intents through reorganisation of the performance goals.

As discussed above, the communication network domain may comprise at least one of a Radio Access Network domain, a Core Network domain, a Transport Network domain, or a Cloud domain. Examples of network customer intents, and associated NF performance goals, for the different domains are discussed above, with reference to method 500.

As discussed above, the methods 300 and 500 may be performed by a learning node, and the present disclosure provides a learning node that is adapted to perform any or all of the steps of the above discussed methods. The learning node may comprise a physical node such as a computing device, server etc., or may comprise a virtual node. A virtual node may comprise any logical entity, such as a Virtualized Network Function (VNF) which may itself be running in a cloud, edge cloud or fog deployment.

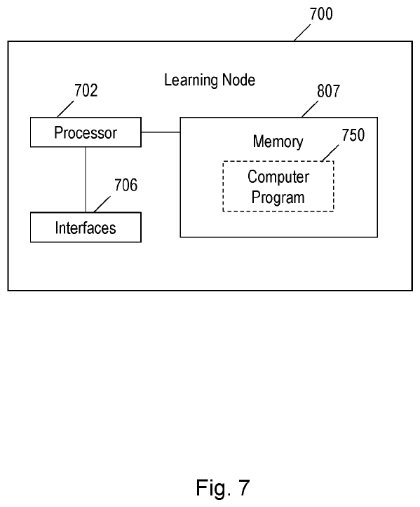

FIG. 7 is a block diagram illustrating an example learning node 700 which may implement the method 300 and/or 500, as illustrated in FIGS. 3 and 5a to 5c, according to examples of the present disclosure, for example on receipt of suitable instructions from a computer program 750. Referring to FIG. 7 the learning node 700 comprises a processor or processing circuitry 702, and may comprise a memory 704 and interfaces 706. The processing circuitry 702 is operable to perform some or all of the steps of the method 300 and/or 500 as discussed above with reference to FIGS. 3 and 5a to 5c. The memory 704 may contain instructions executable by the processing circuitry 702 such that the learning node 700 is operable to perform some or all of the steps of the method 300 and/or 500, as illustrated in FIGS. 3 and 5a to 5c. The instructions may also include instructions for executing one or more telecommunications and/or data communications protocols. The instructions may be stored in the form of the computer program 750. In some examples, the processor or processing circuitry 702 may include one or more microprocessors or microcontrollers, as well as other digital hardware, which may include digital signal processors (DSPs), special-purpose digital logic, etc. The processor or processing circuitry 702 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive, etc. The interfaces 706 may be operable to facilitate communication with a management node, with other learning nodes, and/or with other communication network nodes.

As discussed above, the methods 400 and 600 may be performed by a management node, and the present disclosure provides a management node that is adapted to perform any or all of the steps of the above discussed methods. The management node may comprise a physical node such as a computing device, server etc., or may comprise a virtual node. A virtual node may comprise any logical entity, such as a Virtualized Network Function (VNF) which may itself be running in a cloud, edge cloud or fog deployment.

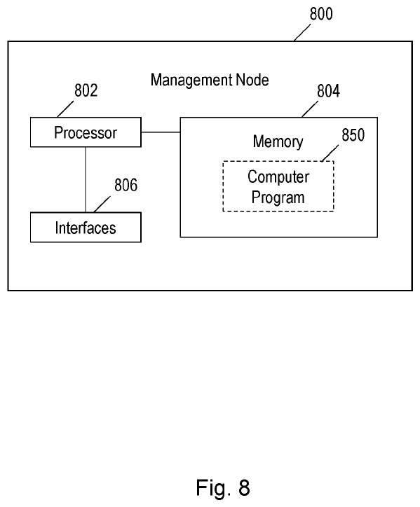

FIG. 8 is a block diagram illustrating an example management node 800 which may implement the method 400 and/or 600, as illustrated in FIGS. 4 and 6a to 6b, according to examples of the present disclosure, for example on receipt of suitable instructions from a computer program 850. Referring to FIG. 8, the management node 800 comprises a processor or processing circuitry 802, and may comprise a memory 804 and interfaces 806. The processing circuitry 802 is operable to perform some or all of the steps of the method 400 and/or 600 as discussed above with reference to FIGS. 4 and 6a to 6b. The memory 804 may contain instructions executable by the processing circuitry 802 such that the management node 800 is operable to perform some or all of the steps of the method 400 and/or 600, as illustrated in FIGS. 4 and 6a to 6b. The instructions may also include instructions for executing one or more telecommunications and/or data communications protocols. The instructions may be stored in the form of the computer program 850. In some examples, the processor or processing circuitry 802 may include one or more microprocessors or microcontrollers, as well as other digital hardware, which may include digital signal processors (DSPs), special-purpose digital logic, etc. The processor or processing circuitry 802 may be implemented by any type of integrated circuit, such as an Application Specific Integrated Circuit (ASIC), Field Programmable Gate Array (FPGA) etc. The memory 804 may include one or several types of memory suitable for the processor, such as read-only memory (ROM), random-access memory, cache memory, flash memory devices, optical storage devices, solid state disk, hard disk drive, etc. The interfaces 806 may be operable to facilitate communication with learning nodes, and/or with other communication network nodes.

It will be appreciated that examples of the learning node and management node described above may operate as a system for managing performance of a communication network domain comprising a plurality of NFs, wherein each NF is operable to execute actions in the communication network domain, and wherein the actions executed by a NF impact at least one performance measure for the communication network domain. Examples of the present disclosure provide such a system, comprising a management node and a plurality of learning nodes, each learning node comprised within a NF in the communication network domain. The management node is configured to provide, to each of a plurality of NFs in the communication network domain, at least one performance goal to be achieved by the NF, and to inform each of the plurality of NFs of which other NFs it should cooperate with to achieve its performance goal. Each of the learning nodes is configured to use a Multi Agent Reinforcement Learning (MARL) process to generate a policy for selecting actions to be executed by its NF so as to achieve its performance goal, wherein the agents in the MARL process comprise the learning node and the learning nodes of each of the NFs that the learning node's NF is to cooperate with.

In some examples, the management node may be configured to provide, to each of the plurality of NFs, an indication of neighbour NFs in the communication network domain, wherein the neighbour NFs comprise NFs that are operable to execute actions in the communication network domain that impact at least one of the performance measures impacted by actions operable to be executed by the NF.

In some examples, each of the learning nodes may be configured to receive, from the management node, the at least one performance goal to be achieved by its NF, and the indication of neighbour NFs in the communication network domain, to obtain a current state representation for the communication network domain, and to receive, from the indicated neighbour NFs, a value of a parameter representing an extent to which the respective neighbour NF is currently able to achieve its performance goal. Each of the learning nodes may be further configured to use the current state representation and received parameter values in a RL process to select an action for execution in the communication network domain, and to initiate execution of the selected action.

In some examples, each learning node may be further configured to send to the management node a latest obtained measure of an extent to which its NF is currently achieving a received performance goal. In such examples, the management node may be further configured, if at least one NF in the plurality has not achieved a performance goal provided to it, to perform at least one of updating performance goals for NFs in the communication network domain, and providing the updated performance goals to the NFs, or informing at least one customer of the communication network that their intent cannot be satisfied by the communication network.

In some examples, each learning node may comprise a learning node 700 implementing examples of the methods 300 and/or 500 as discussed above, and the management node may comprise a management node 800 implementing examples of the methods 400 and/or 600 as discussed above.

FIGS. 3 to 6b discussed above provide an overview of methods which may be performed according to different examples of the present disclosure. These methods may be performed by a learning node and management node respectively, as illustrated in FIGS. 7 and 8. The methods consensus management of individual NFs to achieve their assigned performance goals. There now follows a detailed discussion of how different process steps illustrated in FIGS. 3 to 6b and discussed above may be implemented. The functionality and implementation detail described below is discussed with reference to the modules of FIGS. 7 and 8 performing examples of the methods 300, 400, 700 and/or 800, substantially as described above.

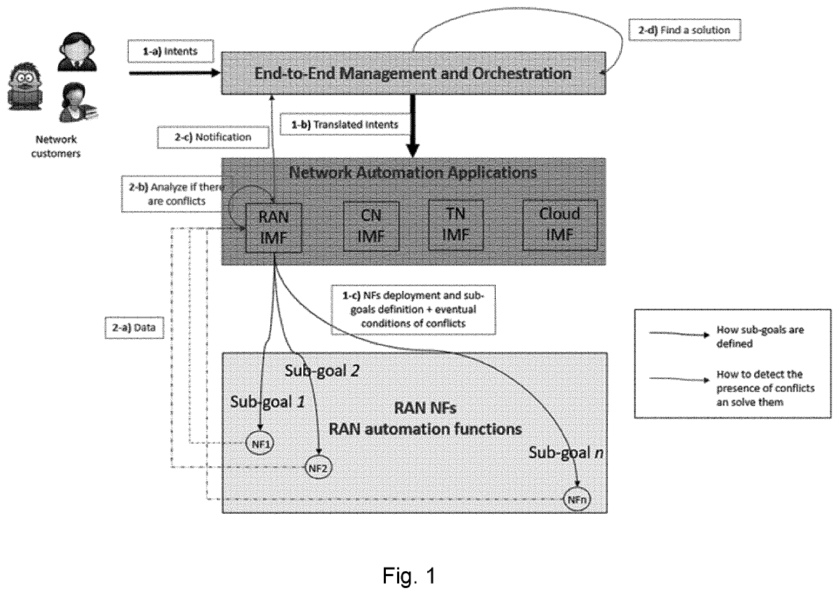

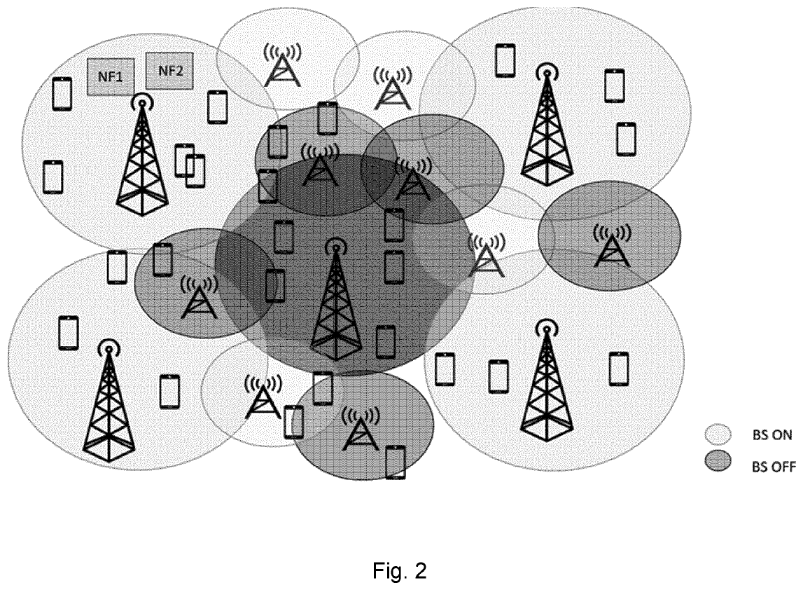

Example methods of the present disclosure may be implemented in a network architecture substantially as illustrated in FIG. 1. It is assumed that the implementation network architecture is composed of three main layers. The higher layer is E2E Management and Orchestration, and is dedicated to business operations. The second layer is used for service operation, and the third layer is used for resource operation. Intent definition starts from the higher layer to which customers submit their requirements. Management nodes (for example implemented as or within IMFs) in the service layer then translate intents to individual performance goals for NFs within their domain, and provide those performance goals to the NFs in the resource layer. At the end of the intent definition process, every NF deployed in the resource operation domain, i.e., RAN, CN, TN, or Cloud will receive a performance goal, referred to in the following description as a sub-goal, that it should achieve. Examples of sub-goals may include reaching less than X quantity of energy consumed during the day, the latency should be less than Y milliseconds, UE throughput should be higher than Z bps, etc.

For the purposes of the present discussion, an implementation is envisaged in which a communication network domain is to be managed comprising n NFs. Every NF i, i∈{1, . . . , n} is responsible for answering its assigned sub-goals denoted as σⁱ. Every NF i comprises at least one learning node operating as a RL agent. Every NF i manages a set of KPIs to achieve its assigned sub-goal, σⁱ. The KPIs that NF i controls, throughout a set of eventual actions Aⁱ, are denoted as Kⁱ. Two or more NFs, i and j, might manage disjoint sets of KPIs, i.e., Kⁱ∩K^{j}≠ø.

At every time t, a learning agent i, operated by a learning node, selects action

$${a}_{t}^{i}$$

∈Aⁱ given state

$${s}_{t}^{i}$$

following local policy πⁱ: S×Aⁱ→[0,1]. πⁱ(s, aⁱ) represents the probability of choosing action, aⁱ at state

$${s}_{t}^{i} . {s}_{t}^{i}$$

presents the state observed by NF i at time t. The state might be composed of the set of KPIs that interest NF i.

For simplicity, the following description avoids using the index i to model the state

$${s}_{t}^{i} ,$$

and as different NFs can have different joint and interfering sub-set of KPIs s is used to denote the joint state,

$${s}_{t} = {⋃}_{i = 1}^{i = n} {s}_{t}^{i} .$$

$${r}_{t + 1}^{i}$$

is the reward received by agent i at time t. The reward is a representation of the NF, (i.e., agent i's) capacity to fulfill its assigned sub-goal σⁱ. This equates to the measure of an extent to which the NF is currently achieving the received performance goal, as referenced in methods 300 to 600. For example: if

$${r}_{t + 1}^{i} \geq {σ}^{i} ,$$

then agent i is respecting the assigned sub-goal σⁱ. Otherwise, agent i is not able to achieve σⁱ. In this case, σ^{i*} denotes the current capability of agent i. For example, if the sub-goal assigned to i is a traffic load higher than 10 Mbps/cell, i.e., σⁱ=traffic load/cell>10 Mbps. If the reward

$${r}_{t}^{i}$$

achieved by i is

$${r}_{t}^{i} = 7 Mbps / cell$$

Mbps/cell that means: agent i is not capable of achieving the assigned sub-goal σⁱ by the policy followed at time t. In this case, σ^{i*}=7 Mbps/cell. Otherwise, if

$${r}_{t}^{i} \geq 10 bps / cell ,$$

then, σ^{i*}=10 Mbps/cell. (See for example steps 560b and 630b).

The joint policy of all NFs, i.e., agents or learning nodes, is defined as π:S×A→[0,1] where π(s, a)=Π_{i∈N}πⁱ(s, aⁱ), A=Π_{i∈N}Aⁱ. Every local policy is parameterized by

$${π}_{{θ}_{i}}^{i}$$

where θⁱ∈Θⁱ is the parameter. The joint policy is

$${π}_{C θ} = {\prod }_{i ∈ N} {π}_{{θ}^{i}}^{i} ( s , {a}^{i} ) .$$

The objective is to enable the set of NFs to reach a consensus throughout the joint policy without revealing their rewards. Through execution of examples of the methods 300 to 600, the different NFs will learn a policy that achieves a good consensus while maintaining privacy of reward (and consequently of assigned sub-goal) from other NFs.

Examples of the methods discussed herein enable different NFs to train their policies while behaving in a closed-loop manner. The NFs collaborate without revealing their sub-goals σⁱ and rewards

$${r}_{t}^{i} .$$

When the different NFs are deployed, or a new NF or a new sub-goal is added to the network, the NFs train or retrain their policies so as to achieve a consensus that satisfies the various intents. The NFs learn to make decisions that maximize a joint action-value function.

As discussed above, example methods of the present disclosure formalize the different deployed NFs as a temporal graph (see steps 602 and 602a of method 600). An edge exists between every two NFs that might conflict, i.e., that manage and impact non-disjoint sets of KPIs. Every edge between two NFs i and j is characterized by the weight cₜ(i, j), which specifies the weight of the impact of NF i's decision on NF j's decision at time t. It is envisaged that the weights cₜ(i, j) are defined by the management node (implemented as or running in a higher-level IMF). These weights may be defined by the management node according to its knowledge of the NFs and their interactions with the network.

The deployed NFs observe the system state. For simplicity, it is assumed in the present example that the n NFs are involved in the graph. The different agents (learning nodes) work to find a joint policy that maximizes the globally averaged long-term return over the network, expressed as:

$${max}_{θ} J ( θ ) = {lim}_{T \to ∞} \frac{1}{T} 𝔼 [ {\sum }_{t = 0}^{T - 1} \frac{1}{N} {\sum }_{i ∈ N} {r}_{t + 1}^{i} ]$$

As set out in Zhang, Kaiqing, et al. “Fully decentralized multi-agent reinforcement learning with networked agents.” International Conference on Machine Learning. PMLR, 2018, the joint action-value function, Q_{θ}(s, a) is qual to:

$${Q}_{θ} ( s , a ) = {\sum }_{t} E [ {\overline{r}}_{t + 1} - J ( θ ) \vert {s}_{0} = s , {a}_{0} , {π}_{θ} ] , where {\overline{r}}_{t} = \frac{1}{N} {\sum }_{t} {r}_{t}^{i}$$

The different NFs are to learn local policies that maximize the globally averaged long-term return, while keeping each local agent's reward private with respect to other NFs, so as to respect privacy requirements of individual network customers, and not reveal their submitted intents to other network customers.

Examples of the present disclosure use the actor-critic algorithm for the multi-agent RL with networked agents introduced in Zhang et al. referenced above:

$${A}_{θ}^{i}$$

is the local advantage function defined as:

$${A}_{θ}^{i} ( s , a ) = {Q}_{θ} ( s , a ) - {\tilde{V}}_{θ}^{i} ( s , {a}^{- i} )$$

Where

$${\tilde{V}}_{θ}^{i} ( s , {a}^{- i} ) = {\sum }_{{a}^{i} ∈ {A}^{i}} {π}_{{θ}^{i}}^{i} ( s , {a}^{i} ) {Q}_{θ} ( s , {a}^{i} , {a}^{- i} ) .$$

a⁻ⁱ denotes the actions of all agents except for i.

In Zhang et al. referenced above, the authors prove that the policy gradient with respect to θⁱ can be obtained locally. However, information about the local rewards of the different agents is exchanged to calculate

$${A}_{θ}^{i} ( s , a ) ,$$

i.e., Q_{θ}(s, a), which is a function of the local rewards. Examples of the present disclosure address this issue by causing every agent (learning node) to maintain its own parameter wⁱ and use the function Q(.,.; w):S×A→ [symbol] . This function is parameterized by w∈ [symbol] ^{K}, where K<<|S|.|A|.

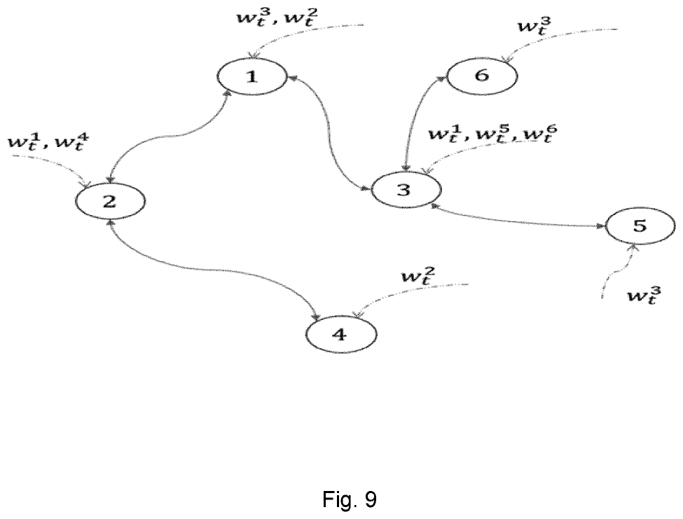

Accordingly, in examples of the present disclosure, every NF i, using an actor critic architecture will have its own estimation Q(s, a, wⁱ) of the joint action value function, i.e., Q_{θ}, of policy π_{θ}. Thus, every NF uses a local parameter wⁱ to estimate Q_{θ}. wⁱ will be shared among neighboring NFs and the reward function will not be revealed. This exchange is illustrated in FIG. 9, which is an example graph of NFs.

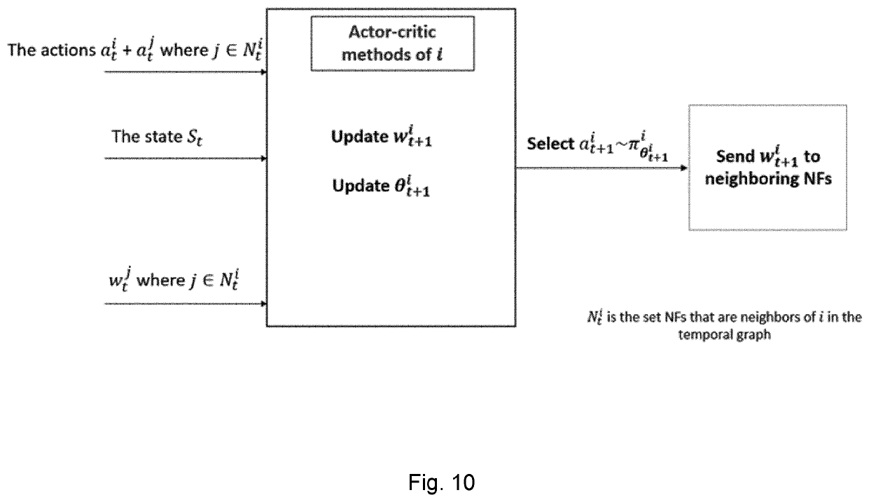

FIG. 10 illustrates actions at a single NF learning node operating agent i. Inputs for the actor-critic methods include the actions of the NF and neighbor NFs in a preceding time step, the state of the communication network domain at the preceding time step, and parameters shared by neighbour NFs representing the extent to which they are able to achieve their assigned sub-goals (performance goals). The learning node then updates its local policy and parameter for sharing, uses the local policy to select an action, causes the action to be executed, and sends the updated parameter to neighbouring NFs.

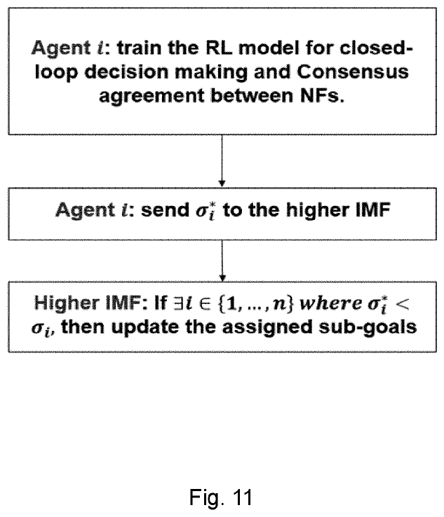

FIG. 11 provides an overview of actions at a system comprising a plurality of agents (learning nodes at individual NFs) and a higher IMF (comprising or running a management node). Referring to FIG. 11, in the first step, the agents (learning nodes) train their local policies using the steps of FIG. 10. After learning the joint policy π_{θ} (FIG. 10), every NF will understand the capability of its learned policy π_{θ}_{ⁱ}, its achieved reward and its capability in terms of achievement of assigned goal σᵢ, i.e.,

$${σ}_{i}^{*} .$$

Every, NF will then send a message including the achieved sub-goal

$${σ}_{i}^{*}$$

to the higher IMF in the second step of FIG. 11. On receipt of the messages, if

$${σ}_{i}^{*} < {σ}_{i} ,$$

for any of the agents, then the higher IMF can proceed, in the third step of FIG. 11, with either updating the sub-goal distribution among the deployed NFs, and/or re-allocate the resources in terms of assigned NFs, and/or deleting the relevant intent as it is not feasible.

Examples of the present disclosure thus provide a distributed strategy for multi-agent reinforcement learning through consensus. Different NFs, working together in a multi-agent reinforcement learning fashion, train their local policy in a way to find a global consensus that maximizes the globally averaged reward function of all the deployed NFs. NFs use an actor-critic algorithm to learn the consensual estimate of the globally averaged reward function in a way that maintains privacy of individual NF rewards (i.e., sub-goals and policies). Once the different NFs finish training and have collaborated to find a good consensus, NFs may communicate their achieved sub-goal to the higher management node (IMF). This step enables a check that the submitted intents are achieved, and consequently that network customers are satisfied.

Examples of the present disclosure thus achieve automated E2E intent management, bringing intelligence to the RAN. Assigned NFs are able to solve intent conflicts locally, thus avoiding the time delay, scaling issues, and single central point of failure characterising existing solutions. NFs operating according to methods of the present disclosure are both more intelligent and more reactive, deciding on their capacity to meet customer requirements. NFs are able to express their current achieved subgoals to the higher IMF and, thus, the end-to-end orchestrator. This avoids delay in existing systems according to which an IMF will observe an NF that can't realize its assigned sub-goal, and the IMF will try to solve the problem in a centralized manner (see FIG. 1). In methods according to the present disclosure, NFs are no longer passive but actively seek a good consensus, and if a consensus can't be found, the relevant NFs can notify the higher IMF, express their capabilities according to the available resources, and send recommendations to the E2E orchestrator. Communication between NFs and higher IMFs is therefore smoother and more helpful.

It will be appreciated that examples of the present disclosure achieve the above discussed advantages while preserving privacy, respecting the privacy requirements of the different customers. Examples of the present disclosure enable different NFs to reach a consensus that does not reveal the intents, or associated subgoals, of the various network customers.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1. A method for managing a Network Function, NF, in a communication network domain, wherein the NF comprises a learning node, and is operable to execute actions in the communication network domain, and wherein the actions executed by the NF impact at least one performance measure for the communication network domain, the method, performed by the learning node of the NF, comprising:
receiving, from a management node in the communication network:
a performance goal to be achieved by the NF; and
an indication of neighbour NFs in the communication network domain, wherein the neighbour NFs comprises NFs that are operable to execute actions in the communication network domain that impact at least one of the performance measures impacted by actions operable to be executed by the NF;
obtaining a current state representation for the communication network domain;
receiving, from the indicated neighbour NFs, a value of a parameter representing an extent to which the respective neighbour NF is currently able to achieve its performance goal;
using the current state representation and received parameter values in a Reinforcement Learning, RL, process to select an action for execution in the communication network domain; and
initiating execution of the selected action.

2. The method of claim 1, further comprising:
obtaining a measure of an extent to which the NF is currently achieving the received performance goal;
generating a value of a parameter representing the obtained measure; and
sending the generated value to the indicated neighbour NFs.

3. The method of claim 1, further comprising:
obtaining a current state representation for the communication network domain;
receiving, from the indicated neighbour NFs, a value of a parameter representing an extent to which the respective neighbour NF is currently able to achieve its performance goal;
using the current state representation and received parameter values in a Reinforcement Learning, RL, process to select an action for execution in the communication network domain;
initiating execution of the selected action;
obtaining a measure of an extent to which the NF is currently achieving the received performance goal;
generating a value of a parameter representing the obtained measure; and
sending the generated value to the indicated neighbour NFs for a plurality of time steps.

4. The method of claim 1, wherein using the current state representation and received parameter values in a RL process to select an action for execution in the communication network domain comprises using the current state representation, received parameter values, and actions executed by the indicated neighbour NFs in a preceding step, in the RL process to select an action for execution in the communication network domain.

5. The method of claim 1, wherein using the current state representation and received parameter values in a RL process to select an action for execution in the communication network domain comprises:
using the current state representation and received parameter values to update a local policy for selecting an action for execution; and
using the updated local policy to select an action for execution in the communication network domain.

6. The method of claim 1, wherein using the current state representation and received parameter values in a RL process to select an action for execution in the communication network domain comprises:
using the current state representation, received parameter values, and actions executed by the indicated neighbour NFs in a preceding step, to update a local policy for selecting an action for execution; and
using the updated local policy to select an action for execution in the communication network domain.

7. The method of claim 6, wherein using the current state representation, received parameter values, and actions executed by the indicated neighbour NFs in a preceding step, to update a local policy for selecting an action for execution comprises:
updating the local policy for selecting an action for execution using a long-term return that is averaged over the NF and the indicated neighbour NFs.

8. The method of claim 7, wherein updating the local policy for selecting an action for execution using a long-term return that is averaged over the NF and the indicated neighbour NFs comprises estimating a joint action value function for the local policy as a function of the received parameter values.

9. The method of claim 2, further comprising:
sending to the management node the latest obtained measure of an extent to which the NF is currently achieving the received performance goal.

10. The method of claim 1, wherein the received performance goal is operable to support fulfilment, within the communication network domain, of at least one communication network customer intent, and wherein a communication network customer intent comprises a performance objective to be achieved in the communication network domain.

11. The method of claim 2, wherein the received performance goal comprises a target value of a performance parameter for the communication network domain, and wherein the measure of an extent to which the NF is currently achieving the received performance goal comprises at least one of:
a value of the performance parameter; and
a percentage amount of the target value of the performance parameter that is currently being achieved.

12. The method of claim 11 wherein the measure of an extent to which the NF is currently achieving the received performance goal comprises a value of the performance parameter that is:
the target value, if the current value of the performance parameter is at least equal to the target value; and
the current value, if the current value of the performance parameter is not at least equal to the target value.

13-14. (canceled)

15. A method for managing performance of a communication network domain, the method, performed by a management node in the communication network, comprising:
providing, to each of a plurality of Network Functions, NFs, in the communication network domain, at least one performance goal to be achieved by the NF; and
providing, to each of the plurality of NFs, an indication of neighbour NFs in the communication network domain, wherein the neighbour NFs comprise NFs that are operable to execute actions in the communication network domain that impact at least one of the performance measures impacted by actions operable to be executed by the NF.

16. The method of claim 15, further comprising generating the indications of neighbour NFs in the communication network domain by:
generating a temporal graph of NFs in the communication network domain, wherein, for each pair of NFs, an edge between the NFs exists in the graph if each of the NFs in the pair is operable to execute actions that impact at least one of the same performance measures; and
for each of the plurality of NFs, generating an indication of neighbour NFs in the communication network domain wherein the indication comprises an identifier of each NF to which the NF is joined in the graph by an edge.

17. The method of claim 15, further comprising:
receiving, from each of the plurality of NFs in the communication network domain, a latest obtained measure of an extent to which the NF is currently achieving the at least one performance goal provided to it.

18. The method of claim 15, wherein each performance goal provided to a NF is operable to support fulfilment, within the communication network domain, of at least one communication network customer intent, and wherein a communication network customer intent comprises a performance objective to be achieved in the communication network domain.

19. The method of claim 17, wherein each performance goal provided to an NF comprises a target value of a performance parameter for the communication network domain, and wherein the measure of an extent to which the NF is currently achieving the received performance goal comprises at least one of:
a value of the performance parameter; and
a percentage amount of the target value of the performance parameter that is currently being achieved.

20. The method of claim 19, wherein the measure of an extent to which the NF is currently achieving the received performance goal comprises a value of the performance parameter that is:
the target value, if the current value of the performance parameter is at least equal to the target value; and
the current value, if the current value of the performance parameter is not at least equal to the target value.

21. The method of claim 17, further comprising, if at least one NF in the plurality has not achieved a performance goal provided to it, performing at least one of:
updating performance goals for NFs in the communication network domain, and providing the updated performance goals to the NFs; or
informing at least one customer of the communication network that their intent cannot be fulfilled by the communication network.

22-23. (canceled)

24. A learning node for managing a Network Function, NF, in a communication network domain, wherein the NF is operable to execute actions in the communication network domain, and wherein the actions executed by the NF impact at least one performance measure for the communication network domain, the learning node comprising processing circuitry configured to cause the learning node to:
receive, from a management node in the communication network:
a performance goal to be achieved by the NF; and
an indication of neighbour NFs in the communication network domain, wherein the neighbour NFs comprise NFs that are operable to execute actions in the communication network domain that impact at least one of the performance measures impacted by actions operable to be executed by the NF;
the processing circuitry further configured to cause the learning node to:
obtain a current state representation for the communication network domain;
receive, from the indicated neighbour NFs, a value of a parameter representing an extent to which the respective neighbour NF is currently able to achieve its performance goal;
use the current state representation and received parameter values in a Reinforcement Learning, RL, process to select an action for execution in the communication network domain; and
initiate execution of the selected action.

25-30. (canceled)
